(19) United States
(12) Patent Application Publication
(10) Pub. No.: US 2026/0311049 A1
(43) Pub. Date: Oct. 8, 2026

(54) METHODS AND SYSTEMS FOR AGENTIC MODEL COMPRESSION

(71) Applicant: Panasonic Well LLC, Palo Alto, CA (US)

(72) Inventors: David Justus, Brooklyn, NY (US); Sandy Anuras, Seattle, WA (US)

(21) Appl. No.: 19/388,909

(22) Filed: Nov. 13, 2025

Related U.S. Application Data
(60) Provisional application No. 63/783,795, filed on Apr. 4, 2025.
(60) Provisional application No. 63/888,098, filed on Sep. 25, 2025.

(51) Int. Cl. G06N 20/00

(52) U.S. Cl. CPC G06N 20/00

(57) ABSTRACT

A model compression system can compress the functionality of large language models into small language models. The model compression system defines a process such as a set of steps that implement an operation. The model compression system also defines a set of use-cases implementing the process and a reward function that quantifies an implementation of the process against target benchmarks. The model compression system finetunes the small language model using the defined process, the use-cases, and the reward function enabling the small language model to execute the process with the same accuracy and precision as the large language model. The small language model may be validated to verify accuracy, precision, drift, etc. and placed in production.

### CROSS-REFERENCE TO RELATED APPLICATIONS

The present patent application claims the benefit of priority to U.S. Provisional Patent Application No. 63/888,098 filed Sep. 25, 2025 and to U.S. Provisional Patent Application 63/783,795 filed Apr. 4, 2025 which are incorporated herein by reference in their entirety for all purposes.

The present patent application is related to U.S. Non-Provisional patent application Ser. No. 19/339,958 filed Sep. 25, 2025 which is incorporated herein by reference in its entirety for all purposes.

### TECHNICAL FIELD

This disclosure relates generally to small machine-learning models, and more agentic-model compression of large language models for small model performance.

### BACKGROUND

Generally, the large machine-learning models are good at processing cross-domain tasks. For example, large language models are good at generating responses to queries involving varied or obscure topics. However, large machine-learning models are much more expensive to train and operate. Large machine-learning models rely on large quantities of graphics processing units to operate and require weeks or months of training and finetuning before being operational. The high cost of building and operating large machine-learning models makes large machine-learning models unsuitable in particular application despite the proficiency of any particular large model. For instance, the need for large quantities of graphics processing units prevents large machine-learning models from operation on edge devices or devices with limited power or processing capabilities.

### SUMMARY

Methods are described herein for agentic-model compression. Some methods may include defining a process including a set of steps that execute an operation; generating, based on the process, one or more reward functions configured to generate scores for particular implementations of the process; executing an implementation of the process using a small machine-learning model and a large machine-learning model, wherein the small machine-learning model generates a first output and the large machine-learning model generates a second output; and training the small machine-learning model based on a composite score generated by the one or more reward functions using the first output and the second output.

Systems are described herein for implementing agentic-model compression. The systems may include one or more processors and a non-transitory computer-readable medium storing instructions that, when executed by the one or more processors, cause the one or more processors to perform any of the methods as previously described.

Non-transitory computer-readable media described herein may be configured to store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example agentic-model compression system (AMCS) that compress processes implemented by large machine-learning models into small machine-learning models according to aspects of the present disclosure.

FIG. 2 illustrates a block diagram of example system for generating small language models according to aspects of the present disclosure.

FIG. 3 illustrates a flowchart of an example process for compressing processes into a small language models according to aspects of the present disclosure.

FIG. 4 illustrates a flowchart of an example process for agentic-model compression of processes into small machine-learning models according to aspects of the present disclosure.

FIG. 5 illustrates an example computing device architecture of an example computing device that can implement the various techniques described herein according to aspects of the present disclosure.

### DETAILED DESCRIPTION

Systems and methods are described herein for agentic-model compression. Agent systems are configured to receive input (e.g., user input, sensor input, and/or inputs), make decisions based on the input, and generate an output. Conventional agent systems use large machine-learning models, which execute multi-step operations to implement agentic processes. For instance, a first large machine-learning model process a communication from the user by performing critical reasoning against a defined criteria, and define an internal state. A second large machine-learning model may process the internal state and historical communications to define a response to the user. The conventional approach is computationally expensive with large processing requirements (e.g., graphics processing units (GPUs), central processing units (CPUs), etc.), data requirements, and power requirements. As a result, conventional agent systems are expensive to operate, slow, and are unsuitable for use in particular applications (e.g., environments with strict power and/or processing resource availability, edge devices, etc.). The agentic-model compression system described herein leverages large machine-learning models to finetune small machine-learning models that enables execution of complex workflows with substantially reduced processing and power requirements.

The agentic-model compression system compresses agentic processes into small machine-learning models, which enables the agentic-mode compression system to implement processes that are conventionally executed by large machine-learning models using small machine-learning models. In some implementations the agentic-model compression system may generate small agent-based models configured to converse with users (e.g., via natural language communications, etc.) or execute tasks for users (e.g., obtain objects or services, interface with third-party services, execute queries, etc.). Agent-based models may receive input (e.g., such as data, natural language communications, etc.) and generate one or more outputs (e.g., natural language communications, structured data, one or more function calls to other services, etc.). The agentic-model compression system can compress any process that may be conventionally implemented by a large machine-learning model into a small machine-learning module such as, but not limited to, classifiers, time-based models, statistical models, inferencing models, image processing models, etc.

The agentic-model compression system may operate as a device (e.g., a computing device, server, etc.) or within a device (e.g., as a software, hardware, and/or a combination of software and hardware, etc.). The agentic-model compression system may include one or more large language models that may provide some functionality of the agentic-model compression system. The agentic-model compression system may periodically compress workflows that may be implemented by the large machine-learning model into small machine-learning models to improve the operating efficiency of the agentic-model compression system. The agentic-model compression system may also define workflows specifically for compression into small machine-learning models. In those instances, the workflows may be new workflows that are not necessarily performed by the large machine-learning model. In some instances, The agentic-model compression system may also generate small machine-learning models (e.g., instantiate an untrained or pretraining model and finetune the model so that the model a configured to provide the functionality of a corresponding large machine-learning model), large machine-learning models, hybrid machine-learning models and/or the like for one or more external devices. Models generated for external devices may be operated by the agentic-model compression system for the external devices or transferred to the external devices upon generation.

The agentic-model compression system may generate small machine-learning models to execute a particular process (e.g., a workflow including a series of steps that may be implemented by a machine-learning model) that when executed implements an operation. The agentic-model compression system may use one or more large machine-learning models to implement the operation (and/or other operations requested users). The agentic-model compression system may generate the small machine-learning model to emulate the large machine-learning model enabling the agentic-model compression system to implement the operation without the processing overhead of the large machine-learning model.

The process can be generic (e.g., a representation of an average operation), abstracted (e.g., a reduced version of a process that is applicable to one or more classes of operations), specific (e.g., targeted process for a particular operation, etc.), and/or the like. The agentic-model compression system may use a large machine-learning model to define the particular process. Alternatively, or additionally, the agentic-model compression system may define the particular process using one or more other techniques such as, but not limited to, one or more previous particular processes defined by the agent-model compression system, user input, a process template, combinations thereof, and/or the like.

The agentic-model compression system defines one or more use cases that implement the defined process. In some instances, the agentic-model compression system uses the large machine-learning model to generate the use-cases. In other instances, the agentic-model compression system generates the use-cases using other techniques (e.g., algorithms, other machine-learning models, user input, etc.). Each use-case may include one or more inputs to the defined process and an output generated by implementing the process. The agentic-model compression system may generate a set of use-cases (e.g., one or more use-cases). If the agentic-model compression system needs additional use-cases, then the agentic-model compression system may generate additional use-cases using the set of use-cases (e.g., using a data generator, etc.). For instance, the agentic-model compression system may define a threshold quantity of use-cases for training the small machine-learning model and/or a threshold quantity of use-cases for finetuning the small machine-learning model. The thresholds may be defined based on the small machine-learning model and the training techniques used to train the small machine-learning model.

The agentic-model compression system then defines one or more reward functions usable to score an output from the large machine-learning model and/or the small machine-learning model. The reward functions operate similar to a loss function during training by evaluating a characteristic of an output (e.g., such as accuracy, semantic similarity, structural similarity, precision, etc.) and using the evaluation in further training. A reward function evaluates a characteristic of the output by comparing the characteristic of the output produced by the small machine-learning model against the characteristic of a known-good output (e.g., generated by passing the same input into the large machine-learning model, defined by the use-case, user input, generated from the use-cases (e.g., using a data generator, etc.), combinations thereof, and/or the like). Each reward function may evaluate a different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like. For instance, the output from the small machine-learning model may be a natural language output that may be compared to a corresponding natural language output generated by the large machine-learning model. A first reward function may compare the semantics of each output and a second reward function may compare the schema of each output (e.g., sentence structure, grammar, diction, etc.). In another instance, the output from the small machine-learning model may be a data output (e.g., such as one or more data values, data structures, etc.) that can be compared directly to the output of the large language model. The reward function may generate an initial score representing an accuracy of the output from the small machine-learning model as compared to the output from the large machine-learning model.

The output of each reward function may be aggregated into a single composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small machine-learning model by comparing the output to a corresponding out from the large machine-learning model (and/or a target output, etc.). The computing device (and/or another reward function) then generates a composite score ‘R’ based on one or more (or all) of the initial scores. In some instances, the large machine-learning model may be configured to implement the reward function to generate the composite score ‘R’.

The agentic-model compression system causes a small machine-learning model to execute a training iteration. The small machine-learning model may be structurally similar to the large machine-learning model. For instance, the large machine-learning model may be a large language model with a particular architecture (e.g., such as, but not limited to, a decoder-only transformer, a encoder-only transformer, Seq2Seq model, etc.). The large language model may include 500 billion parameters or more. For example, a general pretrained transformer (GPT) model includes approximately one trillion parameters. The small machine-learning model may be a small language model including 100 billion parameters or less. The small machine-learning model may include the same architecture as the large language model. Alternatively, the small language model may have a similar architecture (e.g., such as a Seq2Seq model architecture when the large language model is an encoder-only or an encoder only, etc.), or a different architecture. In some instances, the small machine-learning model may be a different type of machine-learning model altogether. For instance, if the large machine-learning model is a large language model, the small machine-learning model may be a recurrent neural network, etc.

In some examples, the agentic-model compression system trains an untrained small machine-learning model. In other examples, the agentic-model compression system executes a finetuning iteration, which finetunes the parameters of the already trained small machine-learning model. The training iteration may be based on reinforcement learning. Reinforcement learning (RL) is a type of machine learning where a machine-learning model learns to make decisions by generating an output, receiving feedback associated with the output, learning based on the combined output and feedback (e.g., adjusting parameters, etc.). Instead of being told a correct output for a given input (as is done in supervised learning), the machine-learning model may generate one or more outputs corresponding to different strategies and adjust the parameters of the machine-learning model to maximize a total cumulative reward over time. For example, reinforcement learning may follow a loop: the machine-learning model receives an input or detects a current state, generates an output or executes an action based on policy, evaluate a reward function based on the output or action, and updates the policy based on the reward function. Over time (e.g., multiple iterations), the machine-learning model can determine a best output for a given input (e.g., the output that corresponds with a highest reward from the reward function).

The reinforcement learning iteration may include the agentic-model compression system defining an input for the finetuning iteration. The input may correspond to an input of a use-case that were previously generated by the large machine-learning model or agentic-model compression system. Alternatively, the input may be defined from a training dataset, user input, procedurally generated, and/or the like. The reinforcement learning iteration may cause the small machine-learning model to generate one or more outputs from the input. The one or more outputs may be evaluated using the reward functions. The reward functions may generate an initial score by comparing the one or more outputs to one or more corresponding outputs generated by the agentic-model compression system or the large machine-learning model. For instance, the agentic-model compression system may pass the same input into the large machine-learning model. Each reward function may generate an initial score by comparing the output from the small machine-learning model to the output from the large machine-learning model. The reward functions may generate one or more initial scores (e.g., one initial score for each reward function, etc.). The agentic-model compression system may generate a composite score from the one or more initial scores.

In some implementations, in addition to generating the composite score, the agentic-model compression system may also generate an average initial score, standard deviation of the initial scores and/or the like. The average initial score and/or standard deviation may be used to standardize the initial scores by determining a relative advantage of each initial score. The reinforcement learning may include a policy update objective that determines how the small machine-learning model is updated based on the initial scores, composite score, average initial score, standard deviation, combination thereof, and/or the like. For instance, the policy update objective may reinforce outputs with positive standardized initial score and may penalize outputs with negative standardized initial score (e.g., while clipping policy changes and encouraging stability, etc.).

Once the reinforcement learning iteration terminates, the small machine-learning model may be validated using the use-cases and/or other training data. By training small machine-learning model using the use-cases and the reward function, the small machine-learning model becomes configured to execute the process defined by the large machine-learning model. The small machine-learning model may be validated by passing input into the small machine-learning model and evaluating the output using the reward function, one or more classifiers, user input, combinations thereof, and/or the like. Validating the small machine-learning model may detect drift (e.g., data drift, concept drift, label drift, and/or the like) and/or training errors (e.g., errors, accuracy issues, etc.). Drift may be detected using statistical techniques (e.g., Kolmogrov-Smirnov test, Chi-Squared, and/or the like), a classifier (e.g., domain classifier, reconstruction error with autoencoders, etc.), embedding distribution shift, perplexity monitoring, error monitoring techniques (e.g., detecting error rates, time between errors, adaptive windowing, etc.), combinations thereof, and/or the like. Alternatively, or additionally, the agentic-model compression system may use one or more other metrics to validate the small machine-learning model (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like). If the small machine-learning model passes validation, the small machine-learning model may begin implementing the process on live data.

The small machine-learning model may be a lightweight version of the large machine-learning model and therefore capable of implementing the process defined by the large machine-learning model with faster execution speeds and fewer processing resources. Once validated, the small machine-learning model can be operated in place of the large machine-learning model for some or all of the functions provided by the large machine-learning model. Operating the small machine-learning model may improve resource efficiency as the small machine-learning model may execute faster using fewer processing resources and less power.

If the small machine-learning model does not pass validation (e.g., drift exceeds a threshold, quantity of errors or error rate is greater than a threshold, accuracy is less than a threshold, etc.), then the agentic-model compression system may return to any previous step (e.g., developing the process, generating use-cases, generating the reward function, executing the finetuning training iteration, and/or validating the small machine-learning model). For example, i some instance, the agentic-model compression system may execute a subsequent finetuning training iteration. In other instances, the agentic-model compression system may start over with a fresh small machine-learning model (e.g., un-doing the previous finetuning training operations to avoid reinforcing the cause of the validation failure. In still yet other instances, the agentic-model compression system may return intermediate step such as generating use-cases and/or defining the reward function (which may have caused the validation failure when the small machine-learning model was trained rather than the training iteration itself).

The agentic-model compression system may generate small machine-learning models to improve an operating efficiency of the agentic-model compression system. For instance, in some examples, the agentic-model compression system may include a resource manager configured to manage various resources of the agentic-model compression system and/or one or more other devices. The resource manager may manage resources of any component of the agentic-model compression system (e.g., individual processing device, distributed processing devices, networks, etc.). Examples of resources managed by the resource manager include, but not limited to, processing resources, network resources, a task execution rate, power consumption, combinations thereof, and/or the like. The resource manage may use one or more metrics to monitor resource consumption such as, but not limited to, memory utilization, memory bandwidth, central processing unit utilization, graphics processing unit utilization, any other processing resource metric, network bandwidth utilization, and/or any other network resources metric, execution rate per task, execution rate per operation, execution rate per process, any other execution rate, power consumption per component of a processing device (e.g., central processing unit, graphics processing unit, memory, network interface, heat, cooling, power consumption of any other component of a processing device, etc.), power consumption per processing device, power consumption per device type, power consumption per network, combinations thereof, and/or the like.

In some implementations, the resource manager may determine resource consumption metrics when implementing a particular process or operation by a large machine-learning model. If the resource consumption is greater than a threshold (or one or more thresholds), then the resource manager may cause the agentic-model compression system to compress the particular process and/or operation into a small machine-learning mode. The threshold may be defined based on target resource consumption metrics for the agentic-model compression system, target resource consumption metrics for one or more large machine-learning models, target performance metrics, combinations thereof, and/or the like.

The agentic-model compression system may also generate small machine-learning models for one or more other devices. For example, the agentic-model compression system may receive a request or a new small machine-learning model. The request may include an identification of the small machine-learning model, one or more properties of the small machine-learning model (e.g., architecture type, size, target output, a target input schema, a target output schema, etc.), a target process to be implemented by the small machine-learning model, an identification of a large machine-learning model that the small machine-learning model is to emulate, an operation that is to be implemented by the small machine-learning model, a processing one or more devices that will execute the small machine-learning model, combinations thereof, and/or the like. The resource manager may predict resource consumption of the requested small machine-learning model, performance metrics of the requested small machine-learning model, resource consumption of the target processing device (or one or more processing devices, or network, etc.), performance metrics of the target processing device (or one or more processing devices, or network, etc.), combinations thereof, and/or the like. For instance, the agentic-model compression system may define a process or operation that is to be implemented by a particular processing device with limited resource availability. The resource manager may predict if the process and/or operation can be implemented by the particular processing device and predict performance characteristics of the process and/or operation or particular processing device if the process and/or operation is implemented by the particular processing device. The resource manager may then determine to compress the process and/or operation based on the processing consumption metrics and/or the performance metrics. For instance, the resource manager may include one or more dynamically defined thresholds based on the process and/or operation and/or the processing device, the one or more processing devices, the network, etc. that will implement the process and/or operation. The one or more thresholds may be defined by the agentic-model compression system, the resource manager, user input, target resource consumption metrics, target performance metrics, available resources, combinations thereof, and/or the like.

In some examples, the agentic-model compression system may transfer the small machine-learning model to the one or more other devices. In other examples, the agentic-model compression system may operate the small machine-learning model for the one or more other devices. In those examples, the agentic-model compression system may receive an execution request that includes one or more inputs. The agentic-model compression system may execute the generated small machine-learning model to generate an output and transmit the output the device that transmitted the execution request. For example, the agentic-model compression system may expose an interface through which one or more external devices may communicate with the agentic-model compression system. The interface may be a graphical user interface, a network interface, an input/output interface, etc. The interface may translate communications from a format of the external device to a native format of the agentic-model compression system. The agentic-model compression system may receive the execution request through the interface, parse the execution request to identify an input for the small machine-learning model, and execute the small machine-learning model using the input. The small machine-learning model may generate an output. The agentic-model compression system may use the interface to communicate the output to the external device. For instance, the agentic-model compression system may display the output, transmit the output, execute the output (e.g., if the output includes executable instructions, etc.), and/or the like.

The agentic-model compression system may be configured to compress any into any small machine-learning model. Examples of machine-learning models include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (e.g., generative pre-trained transformers (GPT), Bidirectional Encoder Representations from Transformers (BERTs), text-to-text-transfer-transformer, and/or the like), generative adversarial networks (GANs), gated recurrent units (GRUs), and/or any other variant of neural networks), statistical classifiers (e.g., Naïve Bayes, logistic regression models, perceptrons, support vector machine, random forest models, linear discriminant analyses models, k-nearest neighbor, boosting, combinations thereof, and/or the like), ensemble models (e.g., Mixture-of-Experts, any other set of two or more models, etc.), combinations thereof, and/or any other machine-learning model type. The large machine-learning models used in the process to generate the small machine-learning model may be of a same, similar, or different architecture from the small machine-learning model. For instance, the large machine-learning model and the small machine-learning model may both be language models (e.g., such as GPTs), different types of language models (e.g., such as a GPT and a BERT, etc.) or different types of models (e.g., such as a GPT and a Mixture-of-Experts, etc.).

In an illustrative example, a computing device may compress a process into a small machine-learning model. The small machine-learning model may be generated by a software component (e.g., executed by one or more hardware components of the computing device) and/or by a hardware component (e.g., central processing units, graphics processing units, application integrated circuits, field programmable gate arrays, systems on a chip, and/or the like) of the computing device. The computing device may be a user device (e.g., a general-purpose computer, a specific-purpose computer, mobile device such as a smartphone or tablet, etc.), a server, a component of a distributed network (e.g., such as a cloud network, etc.). That is, the computing device may be a user device that generates one or more small machine-learning models that may replace the functionality of one or more large machine-learning models operated by the user device. Alternatively, the computing device may be an agentic-model compression system or other processing device, distributed network, etc. that provides machine-learning services to one or more user devices.

The computing device may receive a training dataset for a small language model. The training dataset may include structured and/or unstructured training data, training parameters (e.g., hyperparameters, target learning algorithms, target accuracy metrics, target error metrics, quantity of training iterations, combinations thereof, etc.), an identification of processes and/or steps thereof usable to define processes, process templates, use-case templates, an identification of operations, metadata (e.g., an identification a large machine-learning models that the small machine-learning models will replace, an identification of a target output of the small machine-learning model, a target input of the small machine-learning models, an identification of a process to be emulated by the small machine-learning model, combinations thereof, and/or the like), combinations thereof, and/or the like. The training data may be used to, for example, the small machine-learning model (in implementations where the small machine-learning model is instantiated untrained, etc.), define processes (e.g., from one or more historical processes, process templates, and/or the like), define use-cases of processes (e.g., from one or more historical use-cases, use-case templates, and/or the like), combinations thereof, and/or the like.

In some implementations, the small machine-learning model may be instantiated and trained from scratch. In those implementations, the training data may be usable to train the small machine-learning model. In other implementations, the small machine-learning model may be a pretrained machine-learning model that may be partially or completely trained (e.g., such as a general pretrained transformer, etc.). In those implementations, the training data may be used for finetuning training operations (e.g., transfer learning, metalearning, reinforcement learning, etc.).

The training data may be received from memory of the computing device (e.g., such as a local memory, connected memories, remote memories accessible to the computing device, and/or the like). Alternatively, or additionally, the training data may be received from one or more devices and/or data sources based on the training criteria of the small machine-learning model. For instance, upon receiving a request (or upon executing an operation) to generate a small machine-learning model, the computing device may identify training data from memory of the computing device and/or memory of one or more remote devices and/or data sources usable to train the small machine-learning model. The training data may be selected based on a model type of the small machine-learning model, a model type of a corresponding large machine-learning model that the small machine-learning model will be replacing, a target input of the small machine-learning model, a target output of the small machine-learning model, user input, combinations thereof, and/or the like.

The computing device may define a process for executing an operation. In some implementations, the computing device may use a large machine-learning model to define the process for executing the operation. For instance, the computing device may request the large machine-learning model develop a process (e.g., a set of steps and/or executions of the large machine-learning model) causing the large machine-learning model to output an identification of the process. The large machine-learning model may be configured to execute various operations. For instance, the large machine-learning model may be a large language model configured to operate as an agent for a user, such as, but not limited to, processing natural language communication, generating responses to queries, executing functions (e.g., via one or more application programming interfaces, etc.), invoking one or more external tools, retrieving information, etc. The large machine-learning model may be configured to define a process (e.g., a workflow involving one or more steps that generate a target output, etc.) can be executed by the large machine-learning model to execute the operation. For example, the process may be parsing a natural language query and generating a natural language response, executing a function or invoking a function via an API, invoking an external service, and/or the like. In other implementations, the computing device may define the process using one or more other techniques, such as, but not limited to, one or more algorithms, extracting a process from the training data, adapting a process from the training data, user input (e.g., user defined processes, etc.), combinations thereof, and/or the like.

The computing device may generate one or more use cases that implement the process. In some instances, the computing device may use the large machine-learning model to generate the use-cases. In other instances, the computing device generates the use-cases using other techniques (e.g., algorithms, other machine-learning models, user input, etc.). Each use-case may include one or more inputs to the defined process and a target (known-good) output generated by implementing the process. The computing device may generate a set of use-cases (e.g., one or more use-cases). If the computing device needs additional use-cases, then the computing device may generate additional use-cases using a data generator and the generated use-cases. The data generator may use one or more algorithms to generate additional data (e.g., use-cases) based on an input dataset (e.g., the generated use-cases). Examples of algorithms that may be used include, but are not limited to, grammar-based systems (context-free grammars, etc.), recursive splitting, decision-trees, large language models, generative machine-learning models (e.g., generative adversarial networks, variational autoencoders, diffusion models, etc.), interpolation, extrapolation, synthetic oversampling, procedural data generation, combinations thereof, and/or the like. For instance, the computing device may define a threshold quantity of use-cases for training the small machine-learning model and/or a threshold quantity of use-cases for finetuning the small machine-learning model. The thresholds may be defined based on the small machine-learning model and the training techniques used to train the small machine-learning model.

The computing device may define one or more reward functions usable to score an output from the large machine-learning model and/or the small machine-learning model. The reward functions operate similar to a loss function during training by evaluating a characteristic of an output (e.g., such as accuracy, semantic similarity, structural similarity, precision, etc.) and using the evaluation in further training. A reward function evaluates a characteristic of the output by comparing the characteristic of the output produced by the small machine-learning model against the characteristic of a known-good output (e.g., generated by passing the same input into the large machine-learning model, defined by the use-case, user input, procedurally generated from the use-cases, combinations thereof, and/or the like). Each reward function may evaluate a different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like. For instance, the output from the small machine-learning model may be a natural language output that may be compared to a corresponding natural language output generated by the large machine-learning model. A first reward function may compare the semantics of each output and a second reward function may compare the schema of each output (e.g., sentence structure, grammar, diction, etc.). In another instance, the output from the small machine-learning model may be a data output (e.g., such as one or more data values, data structures, etc.) that can be compared directly to the output of the large language model. The reward function may generate an initial score representing an accuracy of the output from the small machine-learning model as compared to the output from the large machine-learning model.

The output of each reward function may be aggregated into a single composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small machine-learning model by comparing the output to a corresponding out from the large machine-learning model (and/or a target output, etc.). The computing device (and/or another reward function) then generates a composite score ‘R’ based on one or more (or all) of the initial scores. In some instances, the large machine-learning model may be configured to implement the reward function to generate the composite score ‘R’.

The computing device may execute a training iteration for the small language model using the one or more reward functions. If the small machine-learning model is untrained, the training iteration may fully train the small machine-learning model or may be one of many training iterations of the small machine-learning model. If small machine-learning model is pretrained, then the training iteration may be a finetuning step such as reinforcement learning, etc. The training iteration may use the one or more reward functions to train the small machine-learning model to implement the process. In some implementations the training iteration may also include one or more of the use-cases. For instance, the computing device may select a use-case and use execute the small machine-learning model using the selected use-case as input to generate a first output. The computing device may execute the large machine-learning model using the same use-case to generate a second output. Alternatively, the computing device may assign the output of the use-case as the second output, a target output as the second output, and/or any known-good output usable to qualify the first output. The computing device may evaluate the first output using the one or more reward functions. For instance, the first output and the second output may be passed as input into the one or more reward functions, which may output the composite score. The computing device may then update the small machine-learning model based on the composite score. For instance, the computing device may modify parameters of the small machine-learning model or pass the composite score to the small machine-learning model causing the small machine-learning model to modify itself. The training iteration enables the small machine-learning model to execute the process without the processing overhead of the large machine-learning model if the large machine-learning model were to execute the process.

The small machine-learning model may be validated upon termination of the training iterations. Validating the small machine-learning model may include executing the small machine-learning model using the use-cases and comparing the output produced by the small machine-learning model to the target output of the use-case. Alternatively, or additionally, the small machine-learning model may be validated using user input and/or via one or more accuracy metrics.

Once trained, the small machine-learning model may be deployed. The small machine-learning model may be executed by the computing device (e.g., for the computing device or for remote device in communication with the computing device, etc.). Alternatively, or additionally, the small machine-learning may be deployed to one or more remote devices for execution by the one or more remote devices to implement the defined process.

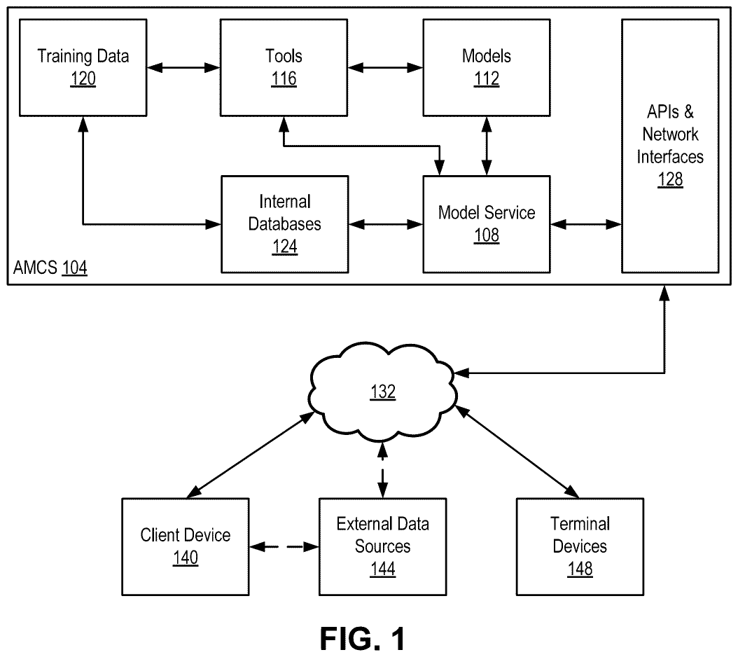

FIG. 1 illustrates a block diagram of an example agentic-model compression system (AMCS) that compress processes implemented by large machine-learning models into small machine-learning models according to aspects of the present disclosure. AMCS 104 may be a platform that provides machine-learning services to users of AMCS 104 and/or to one or more remote devices. The services may include automated agents that may communicate with users via natural language communications, generate responses to queries, execute functions (e.g., via one or more function calls, application programming interfaces, etc.), invoke external services, and/or the like. The automated services may be facilitated by large machine-learning models that may be trained to provide generalized services. AMCS 104 may identify frequently requested services, define processes that facilitate those services using the large machine-learning model, and generate a small machine-learning model that facilitates the services. In some instances, AMCS may also define new processes for new services provided by AMCS 104. AMCS 104 may continue to provide services to users that are facilitated by one or more small machine-learning models resulting in reduced resource consumption per execution and increased execution rates.

AMCS 104 may operate as a hardware platform (e.g., as an application specific integrated circuit (ASIC), field programmable gate array (FPGA), special-purpose processing device, system on a chip (SOC), combinations thereof, and/or the like), a software platform (e.g., executing on a computing device, server, cloud network, a hardware platform as previously described, combinations thereof, and/or the like), or as a combination of a hardware platform and a software platform.

AMCS 104 may include model service 108, an orchestrator service that may manage resources of AMCS 104, manage communications with remote devices, manage large machine-learning models, generate small machine-learning models, generate and manage communications with external devices, facilitate task planning and execution and/or the like. Model service 108 may automate generation of small machine-learning models to improve an operating efficiency of AMCS 104, improve services provided to users, and improve resource consumption of AMCS 104. Model service 108 may determine when and how to generate new small machine-learning models. For example, model service 108 may compress new processes into small machine-learning models or existing processes implemented by large machine-learning models into small machine-learning models. In some examples, model service 108 may generate small machine-learning models to manage existing processes of AMCS 104 (e.g., such as processes implemented by large machine-learning models and process that may be implemented by other components including non-machine-learning components, etc.). In some examples, model service 108 may use a resource manager to determine what processes to compress into small machine-learning models, when to define new processes for compression into small machine-learning models, when to compress processes into small machine-learning models, etc.

For instance, AMCS 104 may execute machine-learning models of models 112 to provide services to users. Some of the machine-learning models of models 112 may be large models. While large machine-learning models may enable executing diverse operations requested by users, those models may be computationally expensive to operate (e.g., consume a large quantity of processing resources such as processing cycles, graphics processing units, memory, network bandwidth, etc.), take a long time to execute and return a result, and consume large amounts of power. Model service 108 may identify commonly requested operations, computational expensive operations (e.g., requests that consume more processing resources than other requests or requests that consume more processing resources than threshold, etc.), etc. and automatically generate small machine-learning models. In some instances, model service 108 may include a resource manager (e.g., as previously described) configured to monitor resource consumption and performance characteristics of AMCS 104 (and/or any component thereof). Model service 108 may trigger compression of particular process and/or generation of small machine-learning models in response to the resource manager detecting resource consumption metrics that are greater than one or more thresholds and/or performance metrics being below one or more thresholds, etc.

If a new small machine-learning model is to be generated (due to any of the aforementioned triggering criteria), then model service 108 may begin generating a new small machine-learning model to replace the functionality of a corresponding large machine-learning model of models 112. The model service 108 may use a large machine-learning model to define a process (e.g., one or more steps) that implements an operation. The small machine-learning model to be generated may be structurally similar to the large machine-learning model. For instance, the large machine-learning model may be a large language model with a particular architecture (e.g., such as, but not limited to, a decoder-only transformer, an encoder-only transformer, Seq2Seq model, etc.). The large language model may include 500 billion parameters or more. For example, a general pretrained transformer (GPT) model includes approximately one trillion parameters. The small machine-learning model may be a small language model that includes 100 billion parameters or less. The small machine-learning model may include the same architecture as the large language model. Alternatively, the small language model may have a similar architecture (e.g., such as a Seq2Seq model architecture when the large language model is an encoder-only or an encoder only, etc.), or a different architecture. In some instances, the small machine-learning model may be a different type of machine-learning model altogether. For instance, if the large machine-learning model is a large language model, the small machine-learning model may be a recurrent neural network, etc.

The process can be generic (e.g., a representation of an average operation), abstracted (e.g., a reduced version of a process that is applicable to one or more classes of operations), specific (e.g., targeted process for a particular operation, etc.), and/or the like. Model service 108 may define one or more use cases that implement the defined process. In some instances, model service 108 uses the large machine-learning model to generate the use cases. In other instances, model service 108 may generate the use cases using other techniques (e.g., algorithms, other machine-learning models, user input, historical operations executed by AMCS 104, previously generated use-cases, etc.). Each use case may include one or more inputs to the process and an output generated by implementing the process.

Model service 108 may generate a set of use-cases. If additional use-cases are needed (e.g., to further train the small machine-learning model, etc.), then model service 108 may use a data generator to generate additional use-cases. The data generator may use one or more algorithms to generate additional data (e.g., use-cases) that is consistent with input dataset (e.g., the set of use-cases). Examples of algorithms that may be used include, but are not limited to, grammar-based systems (context-free grammars, etc.), recursive splitting, decision-trees, large language models, generative machine-learning models (e.g., generative adversarial networks, variational autoencoders, diffusion models, etc.), interpolation, extrapolation, synthetic oversampling, procedural data generation, combinations thereof, and/or the like. For instance, the computing device may define a threshold quantity of use-cases for training the small machine-learning model and/or a threshold quantity of use-cases for finetuning the small machine-learning model. The thresholds may be defined based on the small machine-learning model, the set of use-cases, the defined process, the training techniques used to train the small machine-learning model, combinations thereof, and/or the like.

Model service 108 may define one or more reward functions usable to score an output from the large machine-learning model and/or the small machine-learning model. The one or more reward functions may evaluate an accuracy of an output, which may be used in further training. Each reward function may evaluate a different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like. For instance, the output from the small machine-learning model may be a natural language output that may be compared to a corresponding natural language output generated by the large machine-learning model. A first reward function may compare the semantics of each output and a second reward function may compare the schema of each output (e.g., sentence structure, grammar, diction, etc.). In another instance, the output from the small machine-learning model may be a data output (e.g., such as one or more data values, data structures, etc.) that can be compared directly to the output of the large language model. The reward function may generate an initial score representing an accuracy of the output from the small machine-learning model as compared to the output from the large machine-learning model.

The output of each reward function may be aggregated into a composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small machine-learning model by comparing the output to a corresponding out from the large machine-learning model (and/or a target output, etc.). Model service 108 (and/or another reward function) then generates a composite score ‘R’ based on one or more (or all) of the initial scores. In some instances, the large machine-learning model may be configured to implement the reward function to generate the composite score ‘R’.

In some examples, model service 108 may define the reward function based on previous reward functions defined by model service 108. For instance, previously generated reward functions may be stored in internal databases 124. When a new reward function is needed, model service 108 may identify a closest matching reward function in internal databases 124. Model service 108 may use the closest matching reward function as-is or modify the closest matching reward function for the particular training iteration. Alternatively, model service 108 may define a new reward function without relying on previously generated reward functions. Alternatively, model service 108 may define the reward function based on user input.

Model service 108 may execute one or more training iterations for the small machine-learning model. In some examples, model service 108 trains an untrained small machine-learning model. In other examples, model service 108 executes a finetuning iteration, which finetunes the parameters of the already trained small machine-learning model. The training iteration may be based on reinforcement learning. Reinforcement learning (RL) is a type of machine learning where a machine-learning model learns to make decisions by generating an output, receiving feedback associated with the output, learning based on the combined output and feedback (e.g., adjusting parameters, etc.). Instead of being told a correct output for a given input (as is done in supervised learning), the machine-learning model may generate one or more outputs corresponding to different strategies and adjust the parameters of the machine-learning model to maximize a total cumulative reward over time. For example, reinforcement learning may follow a loop: the machine-learning model receives an input or detects a current state, generates an output or executes an action based on policy, evaluate a reward function based on the output or action, and updates the policy based on the reward function. Over time (e.g., multiple iterations), the machine-learning model can determine a best output for a given input (e.g., the output that corresponds with a highest reward from the reward function). The reinforcement learning iterations may utilize group relative policy optimization, which defines a training policy and uses the reward function to determine how to modify the small machine-learning model according to the training policy. Training may continue until the training policy is satisfied, until particular accuracy metrics are met, etc.

Once trained, model service 108 may validate the small machine-learning model by executing the small machine-learning model using the use-cases, one or more historical operations executed by AMCS 104, and/or the like. The validated small machine-learning model may be configured to execute the defined process with a same accuracy as the corresponding large machine-learning model that defined the process. Since the small machine-learning model is a smaller model than the large machine-learning model (and/or other components of AMCS 104), the process can be executed with much greater efficiency (e.g., increased execution rate, reduced resource utilization, reduced power, etc.). Model service 108 may store the generated machine-learning model in models 112 for later execution.

AMCS 104 may provide services to client devices (e.g., such as client device 140, etc.), terminal devices (e.g., such as terminal devices 148), and/or other remote devices. For example, AMCS 104 may receive an identification of a process and/or operation and use machine-learning models to facilitate execution of the process and/or operation.

Model service 108 may receive input via APIs and network interfaces 128. APIs and network interfaces 128 may include one or more interfaces, libraries, and/or the like that enable AMCS 104 to autonomously access and/or communicate with remote devices (e.g., client devices, servers, databases, webservers, cloud networks, etc.). APIs and network interfaces 128 may translate communications into a native format such as translating received communications into a native format of AMCS 104 and/or translating communications transmitted from AMCS 104 into a native format of the receiving device. APIs and network interfaces 128 may also include interfaces that facilitate access to functions of other devices (e.g., such as, but not limited to, APIs exposed by the other devices, etc.), which enable AMCS 104 to autonomously access and/or manipulate remote devices (e.g., invoking external services, retrieve information, etc.).

Model service 108 may establish a communication session with one or more remote devices such as client device 140, terminal devices 148, and/or one or more other remote devices. For example, client device 140 may connect to AMCS 104 via APIs and network interfaces 128 and establish a communication session. The communication session may be text-based, audio-based, and/or audiovisual-based. In some instances, model service 108 may connect client device 140 to an automated agent via models 112. In other instances, model services may connect client device 140 to a terminal device (e.g., operated by human agents, etc.) such as when AMCS 104 cannot satisfy a particular request, system faults, etc. External data sources 144 may include services associated with client device 140 and/or the user thereof, services that may provide information or facilitate execution of tasks or subtasks, combinations thereof, and/or the like. Examples of external services include, but are not limited to, information sources (e.g., databases, webpages, services subscribed to by the user, etc.), e-commerce platforms, home automation devices, Internet-of-Things devices, wearable devices, sensors, subscription services, combinations thereof, and/or the like. The communication session may include real time communications, non-real time communications, and/or combinations thereof.

Upon establishing the communication sessions, AMCS 104 may connect client device 140 to an automated agent via a large machine-learning model configured to provide automated communication services via natural language communications. Alternatively, AMCS 104 may connect client device 140 to a non-machine-learning automated communication service which may use less processing resources at the expense of more limited communication functionality. The automated communication service may include a classification layer that identifies operations identified as requests within communications. The operations may be tasks, queries, execution of functions (e.g., functions of APIs, remote services, etc.), combinations thereof, and/or the like.

Model service 108 may select a machine-learning model from models 112 to facilitate execution of an identified operation. The input to the machine-learning model may be defined by client device 140 (e.g., as communicated over the communication session), model service 108 from the communication session, and/or the automated communication service, combinations thereof, and/or the like. Model service 108 may attempt to select a small machine-learning model before selecting a corresponding large machine-learning model. If models 112 does not include a small machine-learning model configured to execute the identified operation, then model service 108 may select a large machine-learning model. Model service 108 may execute the selected machine-learning model to facilitate execution of the operation. The selected machine-learning model may retrieve information associated with client device 140 and/or the user thereof connected to the communication session to execute the operations.

AMCS 104 may store information associated with client device 140 and/or users thereof to improve communications, tailor execution of operations, improve execution of AMCS 104. Models 112 may access the information associated with client device 140 to execute various aspects of the process. For instance, a process may include identifying and executing a service of a third-party service provider via an API. Models 112 may access the information associated with client device 140 to identify a particular third-party service provider and/or service. Model service 108 may retrieve any relevant information associated with client device 140 and/or the user thereof to enhance a context of services provided by AMCS 104 and to provide more relevant recommendations to client device 140 and/or the user thereof. For example, model service 108 may retrieve a family profile associated with client device 140 and/or the users thereof. The family profile may include information known about the user including, but not limited to, information received from the user, communications between the user and AMCS 104 (e.g., such as communications with model service 108, terminal devices 148, etc.), task facilitated by AMCS 104, information associated with the user (e.g., information generated through operations of AMCS 104, etc.), demographic information, family information, combinations thereof, and/or the like. AMCS 104 may add to the family profile each time there is an interaction with the user, information associated with the user is generated by AMCS 104, and/or information associated with the user is received by AMCS 104. The family profile may be used to tailor operations of AMCS 104 to the user, which may modify how communications are generated and/or transmitted, how tasks are recommended and/or executed, etc. If no family profile can be identified, then Model service 108 may identify a family profile associated with a related user to the user (e.g., such as family member, etc.), which may include references to the user. If no such family profile can be identified, then Model service 108 may instantiate a new family profile by requesting predetermined information from the user. Model service 108 may retrieve other information associated with client device 140 and/or the user thereof in addition to or in place of the family profile such as, but not limited to, information stored by client device 140 and/or associated with client device 140, external services such as services subscribed to by a user of client device 140, sensors connected to or associated with client device 140, IoT devices connected to or associated with client device 140, home automation devices connected to or associated with client device 140, or any other data source.

The small machine-learning model may use the information associated with client device 140 and/or the user thereof to execute the operation. The small machine-learning model may execute the process to execute the operation, which may generate an output such as, but not limited to a natural language response, execution of a tool of tool 116, execution of a remote service (e.g., of a third-party service provider, and/or the like). The output may be presented to client device 140. For instance, the output may be communicated over the communication session, presented via a graphical user interface, and/or the like.

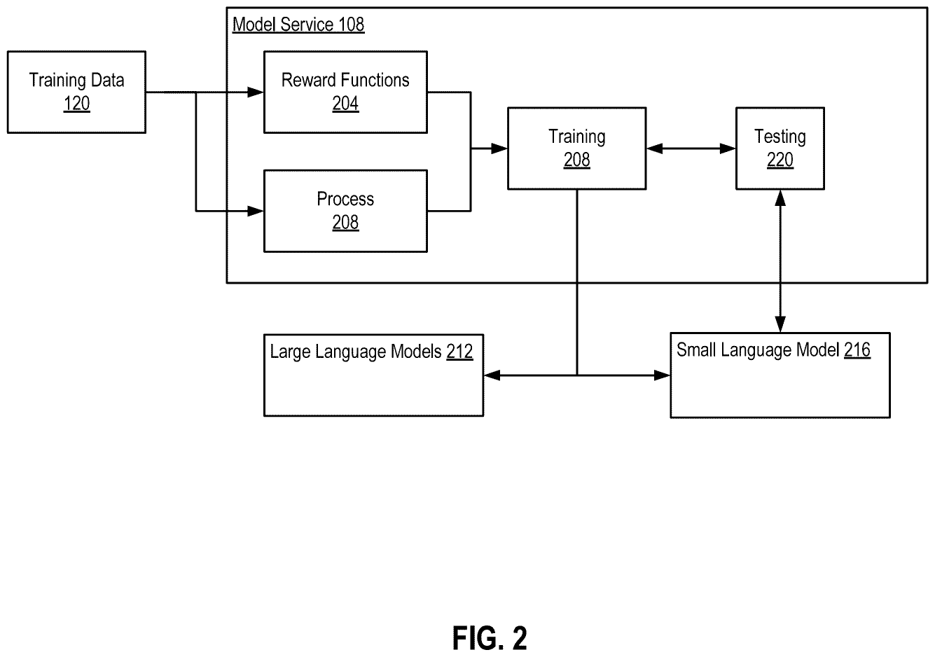

FIG. 2 illustrates a block diagram of example system for generating small language models according to aspects of the present disclosure. Model service 108 of an AMCS may generate small language models by compressing a process into the small language model. In some instances, the AMCS may compress a process that may be implemented by a large language model to reduce resource consumption of the AMCS. In other instances, the AMCS may compress a newly defined process to deploy the process in resource-limited environments. In some implementations, the AMCS may include or use one or more large language models 212 configured to process data such as, but not limited to, sensor data, Internet-of-Things data, natural language communications, etc. Large language models 212 may include a large quantity of parameters (e.g., greater than 500 billion, etc.). The small language model may be structurally the same as, similar to, and/or different from the large language models. For example, the small language model may be small language model 216 including fewer parameters than large language models 212 (e.g., fewer than 100 billion, etc.).

The AMCS may include a model service 108, which may manage operations of the AMCS. Model service may retrieve training data 120, which may include data associated with the large language models 212, data associated with previously generated small language models, data associated with historical process of the AMCS, historical communications between AMCS and users, data associated with historical processes and/or operations of AMCS, metadata, any other data associated with AMCS, combinations thereof, and/or the like. Model service 108 may define process 208 and one or more reward functions 204.

One or more reward functions 204 may be defined based on the small language model to be generated (e.g., small language model 216, etc.), process 208, the operation implemented by process 208, a target output, characteristics of the target output, processing resources of a device configured to execute small language model 216, target performance metrics, combinations thereof, and/or the like. In some implementations, one or more reward functions 204 may be defined at least in part by user input. In other implementations, one or more reward functions 204 may be defined at least in part by large language models 212. In still yet other implementations, one or more reward functions 204 may be defined by model service 108, another component of the AMCS, user input, large language models 212, combinations thereof, and/or the like. The one or more reward functions may be generated from scratch, from one or more previously defined reward functions, and/or the like. Alternatively, the one or more reward functions may be received from local, remote memory, a network connection (e.g., from a remote device, etc.).

Process 208 may be defined based on training data 120, user input, one or more previous processes, templates, large language models 212, and/or the like. In some implementations, process 208 may be defined at least in part by user input. In other implementations, process 208 may be defined at least in part by large language models 212. In still yet other implementations, process 208 may be defined by model service 108, another component of the AMCS, user input, large language models 212, combinations thereof, and/or the like.

One or more use-cases may also be generated as part of compression of process 208. Each use-case may be a different implementation of process 208. Each use-case may include one or more inputs and a target output. The use-cases may be generated based on training data 120, user input, one or more previous processes, templates, large language models 212, and/or the like. In some implementations use-cases may be generated at least in part by user input. In other implementations, use-cases may be generated at least in part by large language models 212. In still yet other implementations, use-cases may be generated by model service 108, another component of the AMCS, user input, large language models 212, combinations thereof, and/or the like.

Training 210 may facilitate training of small language model 216. If small language model 216 is untrained, training 210 may access training data 120 and execute a set of training iterations to train small language model 216. Training 210 may execute a predefined quantity of training iterations and/or train small language model 216 until a target accuracy metric (or other performance metric) is satisfied (e.g., according to one or more thresholds, etc.). Example accuracy metrics include, but are not limited to, accuracy metrics (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like), testing for drift, etc. Once small language model 216 is trained, training 210 may execute finetuning to adapt small language model 216 to process 208.

Once small language model 216 is trained (and/or in instances where small language model 216 is pretrained), training 210 may execute the finetuning of small language model 216. During finetuning, training 210 may execute process 208 using large language models 212 to generate a first output and execute small language model 216 to generate a second output. For example, training 210 may execute each model using a same use-case and/or a same input. Training 210 may use large language models 212 as a benchmark for performance and/or accuracy. Training 210 may then execute a finetuning process (e.g., training, etc.) of small language model 216. For instance, training 210 may evaluate the output of the small language model 216 by comparing the second output to the first output. In some implementations, training 210 may use one or more reward functions 204 to evaluate the outputs. In other implementations, training 210 may use one or more reward functions 204 and one or more other metrics (e.g. loss functions, accuracy metrics, performance metrics, etc.) to evaluate the outputs. In still yet other implementations, training 210 may use one or more other metrics (e.g. loss functions, accuracy metrics, performance metrics, etc.) to evaluate the outputs.

For instance, training 210 may define an input from a use-case of process 208. Training 210 may execute large language models 212 using the input to generate a first output. Training 210 may execute small language model 216 using the same input to generate a second output. Since large language models 212 may be a benchmark for accuracy and/or performance of process 208, the output of large language models 212 (e.g., the first output) may represent a target output. One or more reward functions 204 may evaluate characteristics of the first output by comparing the first output to the second output.

Each reward function may evaluate a different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like. For instance, the output from the small language model may be a natural language output that may be compared to a corresponding natural language output generated by the large language model. A first reward function may compare the semantics of each output and a second reward function may compare the schema of each output (e.g., sentence structure, grammar, diction, etc.). In another instance, the second output from small language model 216 may be a data output (e.g., such as one or more data values, data structures, etc.) that can be compared directly to the first output of large language models 212.

The output of each reward function may be aggregated into a single composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small language model by comparing the output to a corresponding out from the large language model (and/or a target output, etc.). The computing device (and/or another reward function) then generates a composite score ‘R’ based on one or more (or all) of the initial scores. In some instances, the large language model may be configured to implement the reward function to generate the composite score ‘R’.

In some implementations, in addition to generating one or more initial scores and the composite score, one or more reward functions 204 may also generate an average initial score, standard deviation of the one or more initial scores, combinations thereof, and/or the like. The average initial score, standard deviation of the one or more initial scores, etc. may be used to standardize the initial scores by determining a relative advantage of each initial score. The reinforcement learning may include a policy update objective that determines how small language model 216 may be updated based on the initial scores. For instance, the policy update objective may reinforce outputs with positive standardized initial score and may penalize outputs with negative standardized initial score (e.g., while clipping policy changes and encouraging stability, etc.).

During operation of small language model 216, small language model 216 may begin to drift (e.g., diverge in accuracy and/or performance of process 208, etc.). Small language model 216 may be more likely to drift (e.g., diverge from a benchmark accuracy or performance of process 208) than a large language model due to the variation in parameters. Testing 220 may validate an accuracy (or any accuracy metric) or a performance (or any performance metric) of small language model 216 over time. Testing 220 may detect drift before small language model 216 becomes unusable. When drift exceeds a threshold, testing 220 may cause training 210 to execute a subsequent finetuning of small language model 216 to synchronize (e.g., remove the drift) small language model 216 and large language models 212. Testing 220 may be executed continuously (e.g., to evaluate every output of small language model 216), in regular intervals, in response to events, based on user input, based on particular outputs from small language model 216, based on particular inputs to small language model 216, combinations thereof, and/or the like.

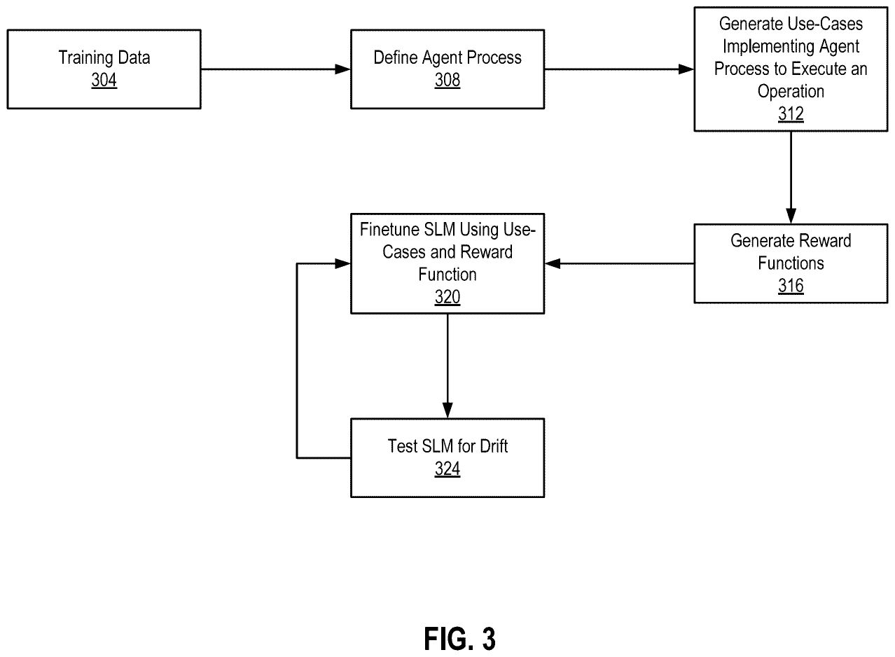

FIG. 3 illustrates a flowchart of an example process for compressing processes into a small language models according to aspects of the present disclosure. At block 304, a computing device receives training data for the small language model. The training data may include training instructions (e.g., metadata, hyperparameters, information associated with a process or operation to be compressed, data associated with historical execution of the large language model, data associated with historical executions of the process or operation, user data, and/or the like).

At block 308, the training data may be used to define a process. The process may include one or more steps to implement an operation such as any user-related task or data processing. For example, a user may request help planning a birthday party for a child leading to a task of “planning a party”. In some instances, the user or an admin user may define a process that implements the operation. In other instances, the large language model may define the set of steps of a processes. For instance, the steps may include selecting a venue, identifying a bakery and ordering a cake, sending invitations, etc. Tasks may range from simple, such as a query for information, to complex (as in the previous example), such as tasks that include multiple steps or subtasks. The large language model may define a set of steps that when executed, implement the requested operation.

At block 312, one or more use-cases may be generated that implement the process. The use-cases may be variations implementations of the operations. For example, if the operation is “plan a party” the use-cases may be plans for different parties (e.g., informal parties, formal parties, etc.). The use-cases may be generated based on previously generated use-cases, templates, based on user input, combinations thereof, and/or the like. Additional use-cases may be generated using a data generator.

At block 316, one or more reward functions can be defined for a training iteration of the small language model. The one or more reward functions may evaluate characteristics of an output of a machine-learning model by comparing the characteristics of the output to corresponding characteristics of a target output. The results of the one or more reward functions may be used for subsequent training of the machine-learning model. Each reward function may evaluate a different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like.

The output of each reward function may be aggregated into a single composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small machine-learning model by comparing the output to a corresponding out from the large machine-learning model (and/or a target output, etc.). A composite score ‘R’ may be generated based on one or more (or all) of the initial scores. In some instances, the large machine-learning model may be configured to implement the reward function to generate the composite score ‘R’. In other instances, the initial scores and/or the composite score may be generated by other processes.

At block 320, the small language model may execute a training iteration. The training iteration may finetune the small language model. In some instances, the training iteration may be based on reinforcement learning such as group relative policy optimization, a variation of group relative policy optimization (e.g., any policy optimization such as trust region policy optimization, etc.). The training iteration may include executing a portion of a use-case and comparing the output of the small language model to the output of the use-case using the reward function. The small language may update internal parameters based on the reward function.

At block 324, the small language model may be validated by using various accuracy metrics (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like), testing for drift, etc.

Once trained (and validated), the small language model will be configured to execute the process at the same degree of precision and accuracy as the large language model that defined the process.

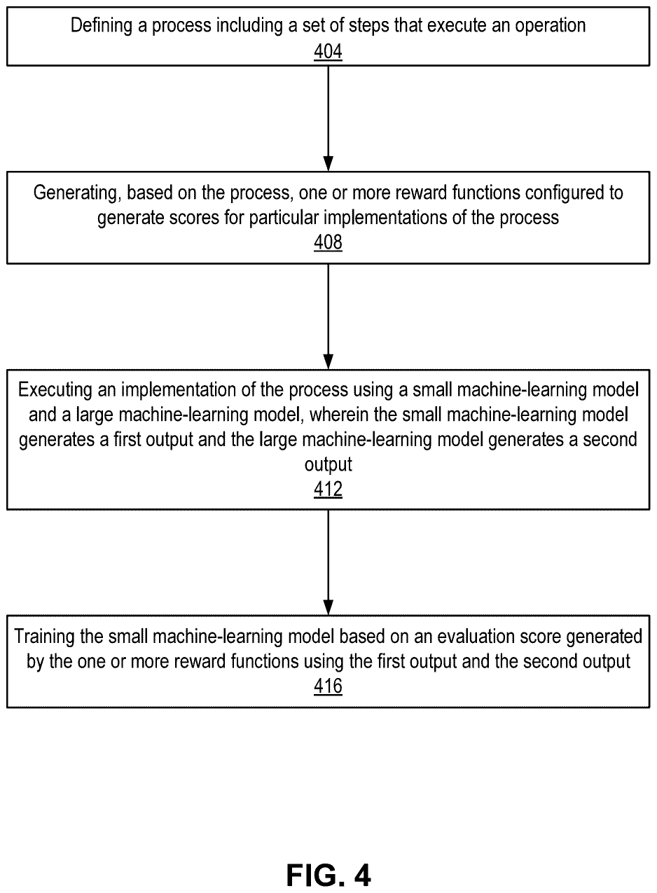

FIG. 4 illustrates a flowchart of an example process for agentic-model compression of processes into small machine-learning models according to aspects of the present disclosure. The computing device may generate small machine-learning models to execute a particular process (e.g., a workflow including a series of steps) that when executed implements an operation (e.g., a task, a request, a calculation, etc.). The computing device may be configured to generate a small machine-learning model that emulates performance characteristics of a large machine-learning model with respect to the process without the processing overhead of the large machine-learning model.

The computing device may be an agentic-model compression system (e.g., as previously described), a user device (e.g., a general-purpose computer, a specific-purpose computer, mobile device such as a smartphone or tablet, etc.), a server, a component of a distributed network (e.g., such as a cloud network, etc.), and/or any other processing device. The computing device may generate the small machine-learning model as a software component (e.g., executed by one or more hardware components of the computing device) and/or as a hardware component (e.g., central processing units, graphics processing units, application integrated circuits, field programmable gate arrays, systems on a chip, and/or the like).

At block 404, the computing device may define a process including a set of steps that execute an operation. In some instances, the computing device may define the particular process using one or more other techniques such as, but not limited to, from one or more previous particular processes defined by the computing device, user input, a template, combinations thereof, and/or the like. In other instances, the process may be defined by a large machine-learning model. The large machine-learning model may be configured to execute various operations. For instance, the large machine-learning model may be a large machine-learning model. The large machine-learning model may be configured to define a process that may be implemented by a machine-learning model.

The computing device may define one or more use cases that implement the defined process. In some instances, the computing device uses the large machine-learning model to generate the use-cases. In other instances, the computing device generates the use-cases using other techniques such as, but not limited, one or more algorithms, one or more other machine-learning models, user input, process templates, historical processes, operation templates, historical operations, etc. Each use-case may include one or more inputs to the defined process. In some instances, each use-case may also include an output generated by implementing the process. The computing device may generate a set of use-cases (e.g., one or more use-cases). If the computing device needs additional use-cases, then the computing device may generate additional use-cases using the set of use-cases (e.g., using a data generator, etc.). For instance, the computing device may define a threshold quantity of use-cases for training the small machine-learning model and/or a threshold quantity of use-cases for finetuning the small machine-learning model. The thresholds may be defined based on the small machine-learning model and the training techniques used to train the small machine-learning model.

At block 408, the computing device may generate one or more reward functions based on the process. The one or more reward functions may be configured to generate scores for particular implementations of the process. The reward functions operate similar to a loss function during training by evaluating a characteristic of an output (e.g., such as accuracy, semantic similarity, structural similarity, precision, etc.) and using the evaluation in further training. A reward function evaluates a characteristic of the output by comparing the characteristic of the output produced by the small machine-learning model against the characteristic of a known-good output (e.g., generated by passing the same input into the large machine-learning model, defined by the use-case, user input, procedurally generated from the use-cases, combinations thereof, and/or the like). Each reward function may evaluate different characteristic of an output. Examples of characteristics include, but are not limited to, semantic similarity, structural similarity (e.g., similar schema, syntax, etc.), overall similarity (e.g., for quantified outputs that can be compared directly), combinations, and/or the like. For instance, the output from the small machine-learning model may be a natural language output that may be compared to a corresponding natural language output generated by the large machine-learning model. A first reward function may compare the semantics of each output and a second reward function may compare the schema of each output (e.g., sentence structure, grammar, diction, etc.). In another instance, the output from the small machine-learning model may be a data output (e.g., such as one or more data values, data structures, etc.) that can be compared directly to the output of the large machine-learning model. The reward function may generate an initial score representing an accuracy of the output from the small machine-learning model as compared to the output from the large machine-learning model.

The output of each reward function may be aggregated into a composite score. For example, each reward function may be distinct function, R=f(x·y), where ‘x’ represents an input to the model and ‘y’ represents an output of the model. Each reward function may generate an initial score, ‘z’ that corresponds to an evaluation of a characteristic of the output from the small machine-learning model by comparing the output to a corresponding out from the large machine-learning model (and/or a target output, etc.). The computing device (and/or another reward function) then generates a composite score ‘R’ based on one or more (or all) of the initial scores. In some instances, the large machine-learning model may be configured to implement the reward function to generate the composite score ‘R’.

At block 412, the computing device executes an implementation of the process using the small machine-learning model and the large machine-learning model. For instance, the computing device may select a use-case and pass the input of the use-case into the small machine-learning model to generate the first output and into the large machine-learning model to generate the second output. The computing device may execute any number of implementations of the process using the small machine-learning model and the large machine-learning model to generate any number of outputs. Each implementation may be based on a different use-case.

At block 416, the computing device trains the small machine-learning model based on an composite score. The composite score may be generated by the one or more reward functions using the first output and the second output. Each reward function may generate an initial score by comparing a characteristic of the first output to a corresponding characteristic of the second output. The composite score generated from the initial score of each reward function (e.g., such as, but not limited to, an average, standard deviation, summation, etc. Alternatively, the composite score may be a particular initial score of a reward function (selected from the initial scores of the one or more reward functions) such as, but not limited to, a median initial score, a mode initial score, a highest initial score, a lowest initial score, or the like. In some implementations, in addition to generating a composite score, the computing device may also generate an average initial score, a standard deviation of the initial scores, and/or the like. The average initial score and/or standard deviation may be used to standardize the initial scores by determining a relative advantage of each initial score. The reinforcement learning may include a policy update objective that determines how the small machine-learning model is updated based on the initial scores, composite score, average initial score, standard deviation, combination thereof, and/or the like. For instance, the policy update objective may reinforce outputs with positive standardized initial score and may penalize outputs with negative standardized initial score (e.g., while clipping policy changes and encouraging stability, etc.). The computing device may train the small machine-learning model over one or more iterations with each iteration using a different use-case (to generate the first output and the second output) and being evaluated by the one or more reward functions. The small machine-learning model may be updated during each iteration to further improve the quality of the output generated by the small machine-learning model.

In some implementations, the reinforcement learning may utilize group relative policy optimization, which defines a training policy and uses the reward function to determine how to modify the small machine-learning model according to the training policy. In other implementations, the computing device may use a variation of group relative policy optimization, other reinforcement learning algorithms, and/or other learning algorithms.

Once trained, the small machine-learning model may be deployed. For example, the computing device may receive a request that includes an input (e.g., from a user operating the computing device and/or from a remote device. The computing device may then execute the small machine-learning model to generate an output based on the request and present the output to the user and/or the remote device.

The small machine-learning model may be validated during operations to ensure accuracy and performance of the small machine-learning model and to detect drift. Validating the small machine-learning model may include executing the small machine-learning model and the large machine-learning model using the use-cases and comparing the outputs from each model (or the target output of the use-case). Alternatively, or additionally, the small machine-learning model may be validated using any accuracy metrics and/or any performance metrics. If the computing device determines that the small machine-learning model fails validation (e.g., drift is greater than threshold, accuracy metrics are below a threshold, performance metrics are below a threshold, etc.), then the computing device may revert to block 412 and reinitiate finetuning of the small machine-learning model.

The example process of FIG. 4 is not limited to language models. Instead, the process of FIG. 4 may compress any process into any small machine-learning model. Examples of small machine-learning models that may be generated by the process of FIG. 4 include but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (e.g., generative pre-trained transformers (GPT), Bidirectional Encoder Representations from Transformers (BERTs), text-to-text-transfer-transformer, and/or the like), generative adversarial networks (GANs), gated recurrent units (GRUs), and/or any other variant of neural networks), statistical classifiers (e.g., Naïve Bayes, logistic regression models, perceptrons, support vector machine, random forest models, linear discriminant analyses models, k-nearest neighbor, boosting, combinations thereof, and/or the like), ensemble models (e.g., Mixture-of-Experts, any other set of two or more models, etc.), combinations thereof, and/or any other machine-learning model type. The large machine-learning model may be of a same, similar, or different architecture from the small machine-learning model. For instance, the large machine-learning model and the small machine-learning model may both be language models (e.g., such as GPTs), different types of language models (e.g., such as a GPT and a BERT, etc.), or different types of models (e.g., such as a GPT and a Mixture-of-Experts, etc.)

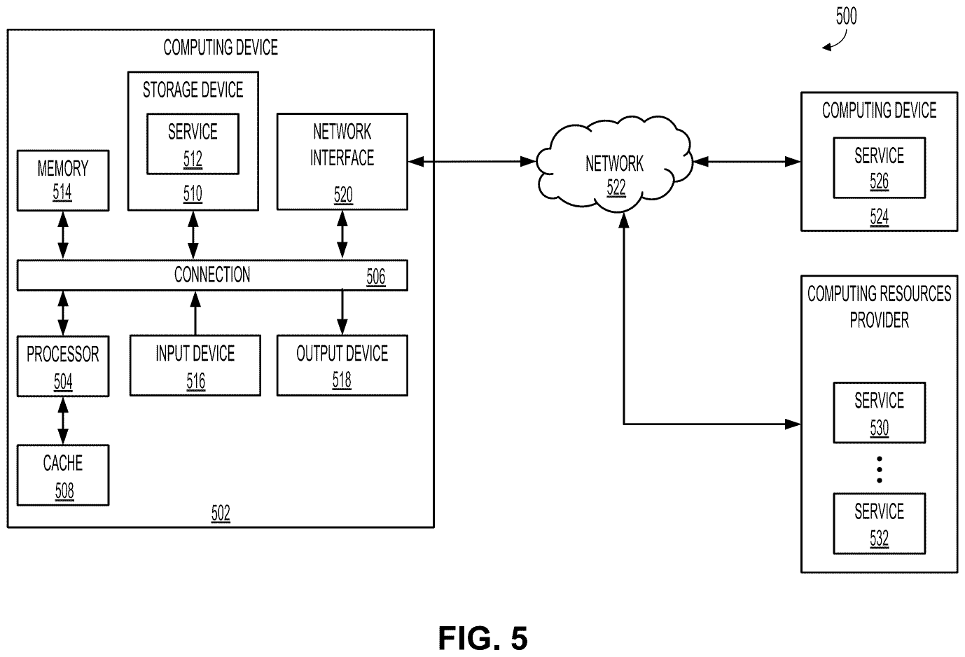

FIG. 5 illustrates an example computing device architecture of an example computing device that can implement the various techniques described herein according to aspects of the present disclosure. The example computing system 500 illustrated in FIG. 5 includes a computing device 502, which has various components in electrical communication with each other using a connection 506, such as a bus, in accordance with some implementations. The example computing system 500 includes a processor 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system 500 includes a cache 508 of high-speed memory connected directly with, in close proximity to, or integrated as part of the processor 504. The computing system 500 can copy data from the system memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The system memory 514 may be referred to herein as system memory or computer system memory. The system memory 514 may include, at various times, elements of an operating system, one or more applications, data associated with the operating system or the one or more applications, or other such data associated with the computing device 502.

Other system memory can be available for use as well. The memory can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system 500, the storage device 510 can be connected to other parts of the computing device 502 using the connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, system memory 514, input device 516, output device 518, and so forth, can carry out the functions such as those described herein.

The disclosed systems and services can be performed using a computing system such as the example computing system illustrated in FIG. 5, using one or more components of the example computing system 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 504 wherein the code is stored in memory such as system memory 514 as described herein. One or more of a user device, a provider server or system, a database system, or other such devices, services, or systems may include some or all of the components of the computing system such as the example computing system illustrated in FIG. 5, using one or more components of the example computing system 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The system memory 514 can be coupled to the processor 504 by, for example, a connector such as connection 506, or a bus. As used herein, a connector or bus such as connection 506 is a communications system that transfers data between components within the computing device 502 and may, in some embodiments, be used to transfer data between computing devices. The connection 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The system memory 514 can include random access memory (RAM) including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The system memory 514 can also include magnetic or optical data storage media including read-only (e.g., CD ROM and DVD ROM) or otherwise (e.g., CD or DVD). The memory can be local, remote, or distributed.

As described above, the connection 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as system memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the one or more services 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 includes a method comprising: defining a process including a set of steps that execute an operation; generating, based on the process, one or more reward functions configured to generate scores for particular implementations of the process; executing an implementation of the process using a small machine-learning model and a large machine-learning model, wherein the small machine-learning model generates a first output and the large machine-learning model generates a second output; and training the small machine-learning model based on a composite score generated by the one or more reward functions using the first output and the second output.

Example 2 includes the method of example(s) 1, further comprising: generating, using a data generator, a set of use-cases, wherein the set of use-cases include implementations of the process to execute the operation, wherein executing the implementation of the process includes executing the small machine-learning model and the large machine-learning model using a same use use-case of the set of use-cases.

Example 3 includes the method of example(s) 1, wherein the small machine-learning model is validated during operations to detect drift.

Example 4 includes the method of example(s) 1, wherein the one or more reward functions defines a score based on a sematic similarity between a known target output and an output of the small machine-learning model.

Example 5 includes the method of example(s) 1, wherein one or more reward functions defines a score based on a degree in which an output from the small machine-learning model adheres to a target schema.

Example 6 includes the method of example(s) 1, wherein one or more reward functions defines a score by evaluating an output from the small machine-learning model using one or more classifiers.

Example 7 includes the method of example(s) 1, wherein the one or more reward functions is executed by the large machine-learning model.

Example 8 includes the method of example(s) 1, wherein training iteration is a reinforcement learning process utilizing group relative policy optimization.

Example 9 is a system comprising: one or more processors; and a non-transitory computer-readable medium storing instructions that when executed by the one or more processors, cause the one or more processors to perform any of example(s) 1-8.

Example 10 is a non-transitory computer-readable medium storing instructions that when executed by one or more processors, cause the one or more processors to perform any of example(s) 1-8.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
defining a process including a set of steps that execute an operation;
generating, based on the process, one or more reward functions configured to generate scores for particular implementations of the process;
executing an implementation of the process using a small machine-learning model and a large machine-learning model, wherein the small machine-learning model generates a first output and the large machine-learning model generates a second output; and
training the small machine-learning model based on a composite score generated by the one or more reward functions using the first output and the second output.

2. The method of claim 1, further comprising:
generating, using a data generator, a set of use-cases, wherein the set of use-cases include implementations of the process to execute the operation, wherein executing the implementation of the process includes executing the small machine-learning model and the large machine-learning model using a same use use-case of the set of use-cases.

3. The method of claim 1, wherein the small machine-learning model is validated during operations to detect drift.

4. The method of claim 1, wherein the one or more reward functions defines a score based on a sematic similarity between a known target output and an output of the small machine-learning model.

5. The method of claim 1, wherein one or more reward functions defines a score based on a degree in which an output from the small machine-learning model adheres to a target schema.

6. The method of claim 1, wherein one or more reward functions defines a score by evaluating an output from the small machine-learning model using one or more classifiers.

7. The method of claim 1, wherein training iteration is a reinforcement learning process utilizing group relative policy optimization.

8. A system comprising:
one or more processors; and
a non-transitory computer-readable medium storing instructions that when executed by the one or more processors, cause the one or more processors to perform operations including:
defining a process including a set of steps that execute an operation;
generating, based on the process, one or more reward functions configured to generate scores for particular implementations of the process;
executing an implementation of the process using a small machine-learning model and a large machine-learning model, wherein the small machine-learning model generates a first output and the large machine-learning model generates a second output; and
training the small machine-learning model based on a composite score generated by the one or more reward functions using the first output and the second output.

9. The system of claim 8, wherein the operations further include:
generating, using a data generator, a set of use-cases, wherein the set of use-cases include implementations of the process to execute the operation, wherein executing the implementation of the process includes executing the small machine-learning model and the large machine-learning model using a same use use-case of the set of use-cases.

10. The system of claim 8, wherein the small machine-learning model is validated during operations to detect drift.

11. The system of claim 8, wherein the one or more reward functions defines a score based on a sematic similarity between a known target output and an output of the small machine-learning model.

12. The system of claim 8, wherein one or more reward functions defines a score based on a degree in which an output from the small machine-learning model adheres to a target schema.

13. The system of claim 8, wherein one or more reward functions defines a score by evaluating an output from the small machine-learning model using one or more classifiers.

14. The system of claim 8, wherein training iteration is a reinforcement learning process utilizing group relative policy optimization.

15. A non-transitory computer-readable medium storing instructions that when executed by one or more processors, cause the one or more processors perform operations including:
defining a process including a set of steps that execute an operation;
generating, based on the process, one or more reward functions configured to generate scores for particular implementations of the process;
executing an implementation of the process using a small machine-learning model and a large machine-learning model, wherein the small machine-learning model generates a first output and the large machine-learning model generates a second output; and
training the small machine-learning model based on a composite score generated by the one or more reward functions using the first output and the second output.

16. The non-transitory computer-readable medium of claim 15, wherein the operations further include:
generating, using a data generator, a set of use-cases, wherein the set of use-cases include implementations of the process to execute the operation, wherein executing the implementation of the process includes executing the small machine-learning model and the large machine-learning model using a same use use-case of the set of use-cases.

17. The non-transitory computer-readable medium of claim 15, wherein the small machine-learning model is validated during operations to detect drift.

18. The non-transitory computer-readable medium of claim 15, wherein the one or more reward functions defines a score based on a sematic similarity between a known target output and an output of the small machine-learning model.

19. The non-transitory computer-readable medium of claim 15, wherein one or more reward functions defines a score based on a degree in which an output from the small machine-learning model adheres to a target schema.

20. The non-transitory computer-readable medium of claim 15, wherein training iteration is a reinforcement learning process utilizing group relative policy optimization.
